(19) United States
(12) Patent Application Publication
(10) Pub. No.: US 2020/0203943 A1
(43) Pub. Date: Jun. 25, 2020

(54) INTELLIGENT TRI-MODE SOLID STATE CIRCUIT BREAKERS

(71) Applicants: Zheng John SHEN, Chicago, IL (US); Yuanfeng ZHOU, Chicago, IL (US)

(72) Inventors: Zheng John SHEN, Chicago, IL (US); Yuanfeng ZHOU, Chicago, IL (US)

(73) Assignee: ILLINOIS INSTITUTE OF TECHNOLOGY, CHICAGO, IL (US)

(21) Appl. No.: 16/645,987

(22) PCT Filed: May 31, 2019
(86) PCT No.: PCT/US2019/034838

§ 371 Date: Mar. 10, 2020

Related U.S. Application Data
(60) Provisional application No. 62/688,461, filed on Jun. 22, 2018.

(51) Int. Cl. H02H 3/02; H02H 1/00; H02H 3/087; H02M 3/156

(52) U.S. Cl. CPC H02H 3/025; H02M 3/156; H02H 3/087; H02H 1/0007

(57) ABSTRACT

A solid-state circuit breaker and method of use. The circuit breaker includes current and voltage sensors, a power converter, and a digital signal processor. The digital signal processor operates the power converter between three operation states: a first operation state being an on state, a second operation state being an off state, and a third operation state being a current limiting state. The circuit breaker includes an overcurrent detection circuit to detect overcurrent conditions, and turn off the power converter if a load current exceeds a preset threshold. The method of operation includes operating the circuit breaker with a limited amount of overcurrent, and returning the circuit breaker to the normal operation state from the third operation state if the overcurrent condition is removed, or returning the circuit breaker to an off state from the third operation state if the overcurrent condition is sustained.

### CROSS REFERENCE TO RELATED APPLICATION

This application claims the benefit of U.S. Application, Ser. No. 62/688,461, filed on 22 Jun. 2018. This co-pending application is hereby incorporated by reference herein in its entirety and is made a part hereof, including but not limited to those portions which specifically appear hereinafter.

### GOVERNMENT SUPPORT CLAUSE

This invention was made with government support under DE-AR0000890 awarded by the Advanced Research Projects Agency—Energy, U.S. Department of Energy. The government has certain rights in the invention.

### BACKGROUND OF THE INVENTION

This invention relates generally to fault protection devices in power distribution systems and, more particularly, to solid state circuit breakers that can quickly interrupt short circuit fault currents.

DC microgrids, such as 380 V DC data center power systems, are gaining tractions in recent years because they offer higher efficiency and lower system cost. However, protecting these DC microgrids from short circuit faults remains a major technical challenge. Traditional electromechanical circuit breakers are too slow and too expensive to interrupt a DC fault current. The inventors disclosed a concept entitled “Self-powered DC solid state circuit breakers” in U.S. Pat. No. 9,543,751, issued on Jan. 10, 2017, herein incorporated by reference. The inventors further reported several self-powered, autonomously operated, wide bandgap (WBG) semiconductor-based solid state circuit breakers (SSCBs) which demonstrated a response time as short as 1 μs, demonstrating significant benefits in power system protection.

However, these ultrafast analog-controlled SSCBs simply respond to an overcurrent condition without distinguishing between a true fault current and an inrush current during the startup of a power electronic load. The inrush current, often several times of the nominal current, is mostly the initial charging current of the large input capacitors of a power converter. The inrush current may cause nuisance tripping of the previously reported SSCBs or even damage in the electronic equipment. There is a continuing need for an intelligent SSCB that can quickly respond to a short circuit fault but support an inrush startup current without nuisance tripping.

### SUMMARY OF THE INVENTION

A general object of the invention is to provide improved solid state circuit breakers that can quickly interrupt short circuit fault currents and facilitate inrush currents during normal load startup.

The general object of the invention can be attained, at least in part, through a solid-state circuit breaker including current and voltage sensors, a power converter, and a digital signal processor in combination with the sensors. The digital signal processor operates the power converter between three operation states, a first of the operation states being an on state, a second of the operation states being an off state, and a third of the operation states comprising a current limiting state. In embodiments of this invention, the circuit breaker includes an overcurrent detection circuit with a comparator, a sequential logic circuit, and/or a logic gate configured to detect overcurrent conditions. The overcurrent detection circuit turns off the power converter once a load current exceeds a preset threshold.

The digital signal processor can operate the power converter in a pulse width modulation current limiting state after the initial shutdown of the power converter upon an overcurrent condition. The digital signal processor can distinguish inrush overcurrent conditions from short circuit faults, and switch the power converter to the off state upon determining a short circuit fault condition. The digital signal processor can operate the power converter in the pulse width modulation current limiting state when an inrush overcurrent condition is determined, and switch the power converter to the on state upon removal of the inrush overcurrent condition.

In embodiments of the invention, the power converter is a variable frequency power converter that operates with variable pulse width modulation frequencies. The power converter is desirably a bi-directional power converter, wherein the power converter conducts power flow in both directions between input and output terminals of the circuit breaker. One or more varistors, can be used to absorb system electromagnetic energy when the power converter is turned off.

The invention further includes a method of operating a solid-state circuit breaker. The method includes: operating the circuit breaker in a first operation state that allows conduction of normal load currents; switching the circuit breaker to a second operation state that shuts down load currents upon detection of overcurrent conditions; operating the circuit breaker in a third operation state that allows a limited amount of overcurrent; and returning the circuit breaker to the first operation state from the third operation state if the overcurrent condition is removed, or returning the circuit breaker to the second operation state from the third operation state if the overcurrent condition is sustained. The invention can also include a step of switching from the third operation state to the second operation state when a short circuit fault is determined during the third operation state. The method thus desirably detects and distinguishes overcurrent conditions as either a short circuit fault or a startup inrush current.

In embodiments of this invention, switching between the operation states of the circuit breaker is controlled by a local digital signal processor in combination with current and voltage sensors, or by remote or manual control commands.

A variable frequency pulse width modulation can be applied during the third operation state to gradually restart the load currents to the first operation state or determine a short circuit fault. A short circuit fault can be determined when the third operation state cannot increase to a load voltage within a predetermined time period.

The third operation state can charge a load capacitor toward a DC bus voltage using the pulse width modulation frequency varying between a lower limit and an upper limit of a power converter of the circuit breaker. The pulse width modulation frequency can be gradually reduced as an output voltage increases toward a DC bus voltage.

In embodiments of this invention the third operation state includes a plurality of sampling cycles, and for each of the sampling cycles the method includes: determining a difference between a DC bus voltage and an output voltage; returning the circuit breaker to the first operation state if the difference is less than a predetermined threshold; returning the circuit breaker to the second operation state upon determining the third operation state exceeds a predetermined time limit; and starting a further cycle of the third operation state upon the returning to the second operation state. Each of the sampling cycles of the third operation state can include: charging a load capacitor toward a DC bus voltage using a pulse width modulation frequency; and gradually reducing the pulse width modulation frequency until an output current exceeds a predetermined overcurrent threshold.

Other objects and advantages will be apparent to those skilled in the art from the following detailed description taken in conjunction with the appended claims and drawings.

### BRIEF DESCRIPTION OF THE DRAWINGS

FIG. 1 is a schematic including a solid state circuit breaker according to one embodiment of this invention.

FIG. 2 illustrates a tri-mode control strategy for a solid state circuit breaker according to one embodiment of this invention.

FIG. 3 is a graph illustrating an algorithm for generating a variable PWM frequency between the upper and lower limits for a fixed PWM off time of 1 μs, according to one embodiment of this invention.

FIG. 4 is a flowchart of a soft start according to one embodiment of this invention.

FIG. 5 is a simulated waveforms of a PWM control signal, load voltage, and inductor current for a load capacitor of 45 μF, according to one embodiment of this invention.

FIG. 6 is measured waveforms of a load voltage and solid state circuit breaker current during a soft-start with a 90 μF capacitor, according to one embodiment of this invention.

### DESCRIPTION OF THE INVENTION

This invention includes and provides an intelligent solid state circuit breaker (SSCB). Embodiments of this invention include a current limiting soft startup function in addition to the basic fault current interruption function.

The SSCB of embodiments of this invention includes three distinct operation states: ON, OFF, and a current limiting (CL) state. While the ON state allows continuous conduction of normal load currents, and the OFF state interrupts any fault currents, the CL state allows the SSCB to gradually charge the input capacitors of the electronic load at a limited current level during startup. The SSCB can switch from the CL state to the OFF state if it senses a true short circuit fault after a short detection time window. Embodiments incorporate a buck converter topology with a variable frequency pulse width modulation (PWM) control algorithm to optimally start up the load or distinguish a short circuit fault without overstressing the system. The invention further provides a hybrid controller for the SSCB that combines flexibility and programmability of digital control, and ultrafast response of analog control.

The invention is useful in DC power systems to provide protection against short circuit faults. Initial and direct applications include large data centers, photovoltaic solar farms, naval ships, and other DC microgrid systems. Other uses include high voltage DC transmission systems (HVDC) and medium voltage DC distribution power systems. It can be adapted into AC power systems as well.

There are no fundamental technical or regulatory limitations of the invention. Although the invention can use both silicon and more expensive wide bandgap (WBG) semiconductor switches, it is understood that WBG semiconductors such as SiC and GaN are more appropriate for voltage ratings over 300 volts. At present, WBG semiconductors are much more expensive than silicon, but have started to enter the mainstream commercial market with heavy investment from the government and industry. The invention can actually aid this WBG commercialization process as a “killer app”.

A simple SSBC design for interrupting fault currents is typically composed of a silicon or WBG static switch, sensing and control electronics, auxiliary power and communication circuits, and energy absorption components such as MOV. However, current limiting functions sometimes are needed for many types of SSCBs. In order to operate in the startup mode without nuisance tripping, embodiments of this invention add the CL mode to the simple ON and OFF operation in the SSCB design.

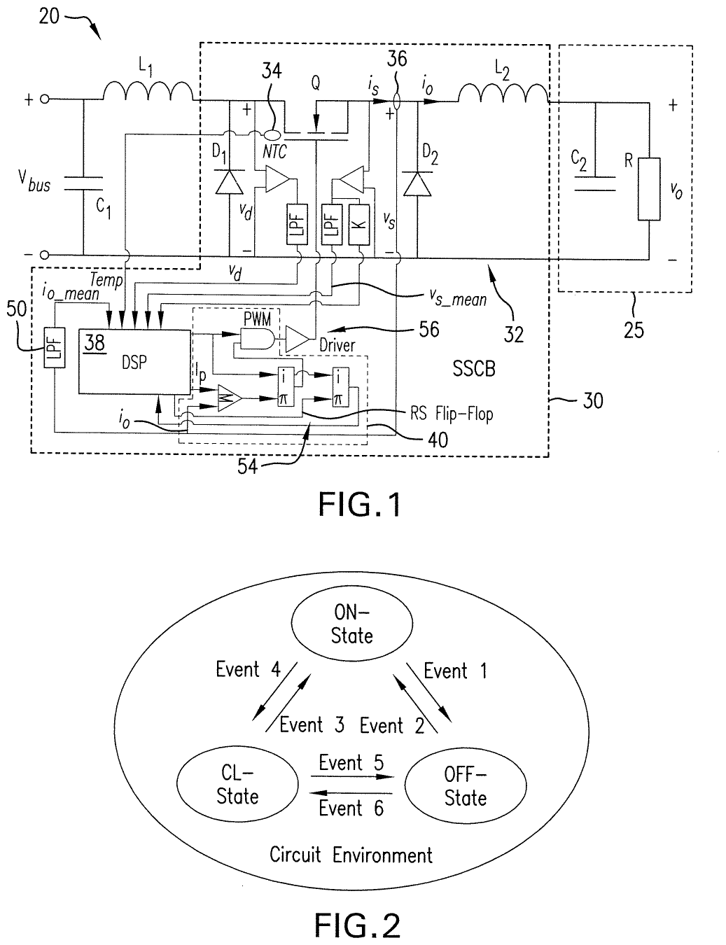

FIG. 1 shows a simple buck topology to facilitate such a fault current limiting function. FIG. 1 shows a DC bus 20, a load model 25, and a solid-state circuit breaker 30 therebetween. The SSCB 30 includes a buck converter 32, current/voltage/temperature sensors 34, 36, a digital signal processor 38, and an overcurrent detection circuit 40.

The digital signal processor (DSP) 38 is used to control the operation of the SSCB 30, and has analog-to-digital converter (ADC), digital-to-analog converter (DAC), pulse width modulation (PWM), universal asynchronous receiver transmitter (UART), and general purpose input output (GPIO) modules. Voltage and current sensors 36 are used to constantly sense the DC bus voltage v_{d}, node voltage vₛ, and MOSFET current iₛ. Note that only the DC components of vₛ, v_{d} and is are fed to the ADC module of the DSP through a low pass filter (LPF). The DSP 38 reads these input signals once in every sampling cycle (e.g., every 72 μs), and runs different control programs based on these signals. In addition, a comparator 52, two RS flip-flops 54 and several logic gates 56 inside the DSP 38 are used to continuously detect and register overcurrent conditions due to either a short circuit fault or a startup inrush current. The instantaneous MOSFET current iₛ before the LPF is constantly compared with a current threshold Iₚ, which is the maximum current of the SSCB set by the DSP's DAC module (e.g., 40 A or 2X of the SSCB's nominal current of 20 A). If iₛ is less than Iₚ, MOSFET Q can be solely controlled by the DSP 38. If iₛ exceeds Iₚ, the overcurrent detection circuit 40 will turn off Q immediately to limit the output current of the SSCB 30, and at the same time send an overcurrent status report signal to the DSP 38. The DSP 38 will then initiate a soft startup program and find out the reason of the overcurrent condition. If it is due to an inrush current, the SSCB 30 will charge the capacitive load to the DC bus voltage through a PWM operation of the buck converter. The pulse width of vₛ is measured using the DSP's 38 capture function when the SSCB 30 operates in a PWM mode to limit the output current. After the successful startup, MOSFET Q will stay on. If the soft startup operation cannot increase the load voltage within a specified time period, it is deemed that the overcurrent condition is due to a short circuit fault. Therefore, Q will turn off and remain off.

Combining the flexible but slow DSP with the analog-like overcurrent detection circuit leads to an optimal solution to maintain an ultrafast us-scale response time while gaining digital programmability for the new SSCB. The SSCB also draws power from the positive and negative power busses to supply the control electronics through an isolated DC power module. An NTC sensor can be used to monitor the MOSFET's temperature for over-temperature protection of the SSCB. A wireless communication device/module (e.g., Bluetooth™ or other wireless protocol) can also be included in the SSCB for wireless communication of status reporting and remote switching functions.

The SSCB offers three distinct operation states: ON, OFF, and current limiting, hereinafter also referred to as PWM current limiting (PWM-CL). While the ON state allows continuous conduction of normal load currents, and the OFF state disallow any current flow, the PWM-CL state allows the SSCB to gradually charge the input capacitor of electronic loads at a limited current (e.g., 2X of nominal) level during startup. In the CL state, the MOSFET switches at a variable PWM frequency to optimally facilitate the startup process. Note that the SSCB only operates in the CL mode for a short time period (milliseconds), and then will shift to the ON or OFF state depending on the circumstances. Such a tri-mode control strategy is described as a finite state machine (FSM) in FIG. 2.

Transition among the three states is driven by events, listed as Events 1 to 6 in FIG. 2. Event 1 covers at least one of the following conditions: overload of the SSCB (but still below the overcurrent threshold Iₚ) for an extended time period (e.g., 30 seconds); manual or remote turnoff of the SSCB; or over-temperature of the MOSFET. When Event 1 occurs, the SSCB will shift from ON state to OFF state. Event 2 covers the case of manual or remote turn-on of the SSCB. When Event 2 occurs, the SSCB will shift from OFF state to ON state. Event 4 occurs when the MOSFET current iₛ exceeds the overcurrent threshold Iₚ, the SSCB will then shift from the ON state to the CL state. In the CL state, the DSP can run a soft start program, and control the MOSFET with a variable frequency PWM algorithm. The root cause of the overcurrent scenario will be determined by the soft start routine. In the case of inrush current, the SSCB will return to the ON state after successfully charging the input capacitor of the load to the DC bus voltage, as indicated by Event 3. If the overcurrent is due to a short circuit fault, the SSCB will shift to the OFF state, as indicated by Event 5. In the CL state, the average current through the MOSFET is always less than Iₚ since the PWM duty cycle is less than 100%. The DC source and the power line, if sufficiently designed, will not be subject to thermal overstress since the SSCB only operates in the CL state for a very short time period (e.g., a few ms). Event 6 covers situations such as reclosing of the SSCB immediately after a short circuit shutdown or a scheduled soft start of a load.

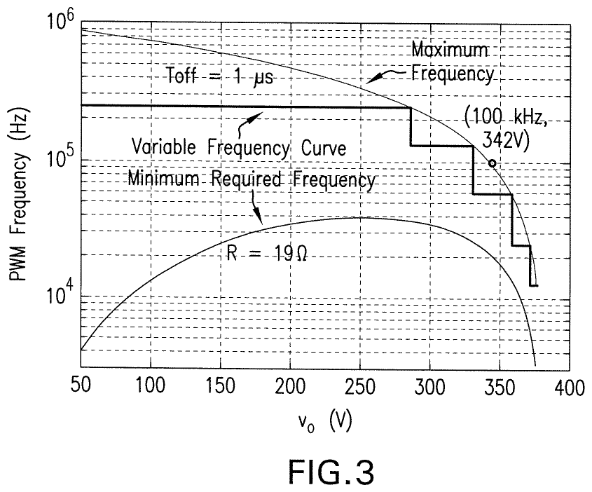

Most ICT equipment has an input capacitor filter in a range of several to tens of μF. The input capacitance can be as large as thousands of μF in aircrafts. When these loads with input capacitors are connected to a DC bus, there will be a very large initial inrush current to charge these capacitors. SSCB of this invention can operate in the PWM-CL state to limit the inrush current under a certain value and gradually charge the capacitor voltage to the DC bus voltage. Embodiments include a variable frequency PWM control algorithm to optimally charge the load capacitor to a voltage reasonably close to the DC bus voltage when a fixed PWM off time is used. FIG. 3 shows an exemplary minimum and maximum PWM frequencies required to charge up the input capacitor to a certain voltage level. A PWM frequency is selected between these lower and upper limits for the buck converter. If a fixed PWM frequency of 100 kHz is chosen, then the output voltage would be charged to around 342V (dot in FIG. 3), leaving a large difference of 28V below V_{bus}. If the MOSFET is left on at this moment, there would be a large inrush current because of this voltage difference.

Embodiments of this invention include a more optimal variable PWM frequency algorithm which gradually reduces the PWM frequency as the output voltage vₒ increases to approach the DC bus voltage, as indicated by the multistep purple line in FIG. 3. When the voltage difference is less than 5V, the PWM operation can be stopped and the MOSFET left in the ON state. This is a basic concept of the variable frequency PWM algorithm for the buck converter.

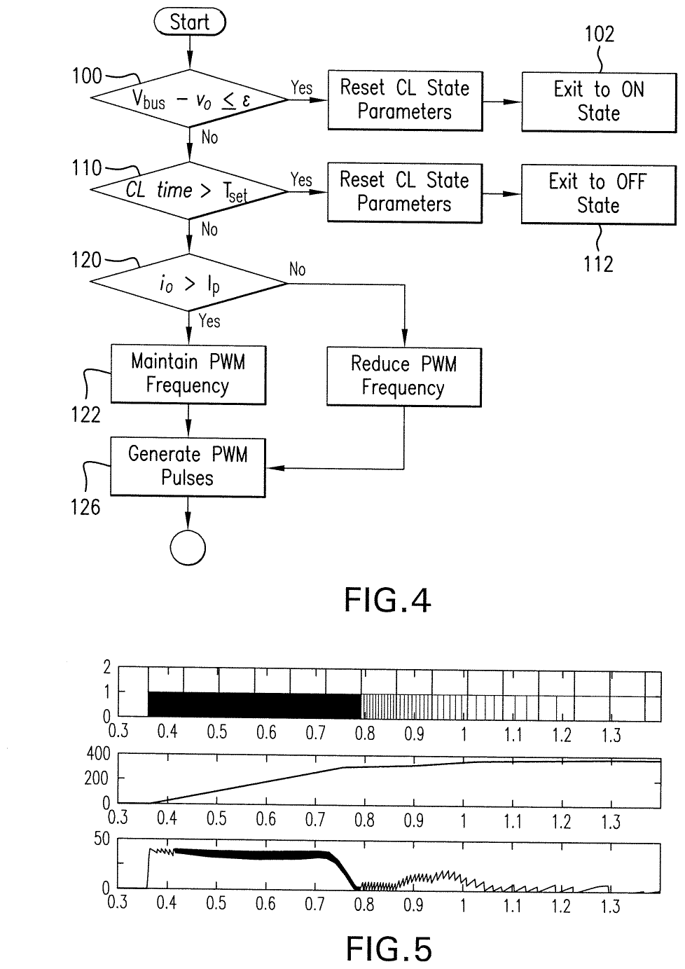

FIG. 4 is an exemplary flowchart of a DSP soft start program based on the variable frequency PWM strategy of one embodiment of this invention. At each sampling cycle, the DSP examines the difference between the DC bus voltage and the output voltage. If the error is less than a preset threshold in step 100, the DSP sends the SSCB to the ON state (step 102). Otherwise, in step 110, the DSP will next check if the soft start process exceeds a preset time limit, and send the SSCB to the OFF state (step 112) if the answer is YES. Otherwise, in step 120, the DSP will next check if the output current exceeds the preset overcurrent threshold, and continue the PWM operation (step 126) at the same PWM frequency (step 122) if the answer is YES. Otherwise, the buck converter will operate (step 126) at a reduced PWM frequency (step 124). The soft start routine will continue until the end of the sampling period, or exit to either the ON or OFF state as described early.

FIG. 5 shows simulated waveforms of a PWM control signal, with the load voltage vₒ, and inductor current iₒ for an RC load of 45 μF/19Ω. The sampling time of the control electronics was set at 72 μs, so the PWM period could be varied at a fraction of 72 μs. Initially, the SSCB was in the OFF state. At t=0.36 ms, the SSCB turned on and immediately encountered a large inrush current, and thus shifts into the CL state. The soft start program was therefore initiated. For the first six sampling periods, the PWM period was set at 4 μs (corresponding to an initial PWM frequency of 250 kHz). Starting from the seventh sampling period, the PWM period changed to 6 μs, 12 μs, 18 μs, 24 μs, 36 μs, and 72 μs, respectively, corresponding to a gradually reduced PWM frequency and pulses per sampling period. The DSP initially generates a PWM duty ratio of 0.75, which was then adjusted by the overcurrent detection/register circuit to control the actual switching of the power MOSFET Q as shown in FIG. 1. After 1.3 ms, vₒ was almost the same as V_{bus}. The MOSFET turned on and the SSCB stayed in the ON state.

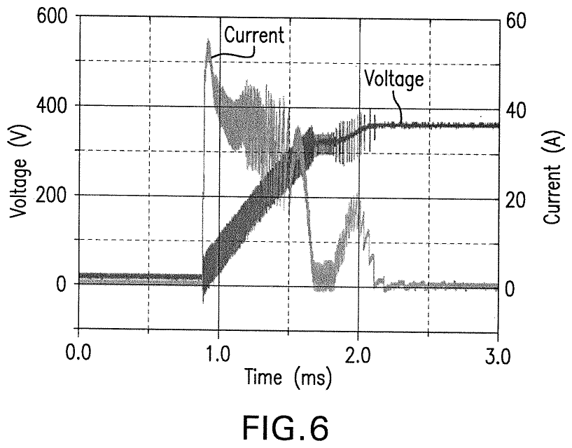

FIG. 6 shows measured iₒ and vₒ waveforms for a 90 μF pure capacitor load. The SSCB was initially in the OFF state. The output voltage vₒ was 0V. The capacitor was connected. At time 0.9 ms, MOSFET turned on and SSCB entered ON state. Because of the inrush current of capacitive load, there was over current protection and SSCB entered CL state. SSCB began the soft-start with the capacitor. After 1.2 ms, the soft start succeeded. SSCB enters ON state. Output voltage vₒ was 380V. The inductor current reduced to 0 A.

Thus, the invention provides solid state circuit breakers that can quickly interrupt short circuit fault currents but facilitate inrush currents during normal load startup.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. A solid-state circuit breaker comprising:
current and voltage sensors;
a power converter; and
a digital signal processor in combination with the sensors, wherein the digital signal processor operates the power converter between three operation states, a first of the operation states being an on state, a second of the operation states being an off state, and a third of the operation states comprising a current limiting state.

2. The circuit breaker according to claim 1, further comprising an overcurrent detection circuit comprising a comparator, a sequential logic circuit, and/or a logic gate configured to detect overcurrent conditions, wherein the overcurrent detection circuit turns off the power converter once a load current exceeds a preset threshold.

3. The circuit breaker according to claim 2, wherein the digital signal processor operates the power converter in a pulse width modulation current limiting state after the initial shutdown of the power converter upon the overcurrent condition.

4. The circuit breaker according to claim 3, wherein the digital signal processor distinguishes inrush overcurrent conditions from short circuit faults, and switches the power converter to the off state upon determining a short circuit fault condition.

5. The circuit breaker according to claim 3, wherein the digital signal processor continues to operate the power converter in the pulse width modulation current limiting state when an inrush overcurrent condition is determined, and switches the power converter to the on state upon removal of the inrush overcurrent condition.

6. The circuit breaker according to claim 1, further comprising a variable frequency power converter, wherein the digital signal processor operates the power converter with variable pulse width modulation frequencies.

7. The circuit breaker according to claim 1, further comprising a bi-directional power converter, wherein the power converter conducts power flow in both directions between input and output terminals of the circuit breaker.

8. The circuit breaker according to claim 1, further comprising at least one varistor, wherein the at least one varistor absorbs system electromagnetic energy when the power converter is off.

9. A method of operating a solid-state circuit breaker, the method comprising:
operating the circuit breaker in a first operation state that allows conduction of normal load currents;
switching the circuit breaker to a second operation state that shuts down load currents upon detection of overcurrent conditions;
operating the circuit breaker in a third operation state that allows a limited amount of overcurrent; and
returning the circuit breaker to the first operation state from the third operation state if the overcurrent condition is removed, or returning the circuit breaker to the second operation state from the third operation state if the overcurrent condition is sustained.

10. The method of claim 9, wherein switching between the operation states of the circuit breaker is controlled by a local digital signal processor in combination with current and voltage sensors, or by remote or manual control commands.

11. The method of claim 9, further comprising switching from the third operation state to the second operation state when a short circuit fault is determined during the third operation state.

12. The method of claim 9, further comprising detecting and distinguishing overcurrent conditions as either a short circuit fault or a startup inrush current.

13. The method of claim 9, further comprising applying a variable frequency pulse width modulation during the third operation state to gradually restart the load currents to the first operation state or determine a short circuit fault.

14. The method of claim 13, further comprising determining the short circuit fault when the third operation state cannot increase to a load voltage within a predetermined time period.

15. The method of claim 9, wherein the third operation state comprises charging a load capacitor toward a DC bus voltage using a pulse width modulation frequency varying between a lower limit and an upper limit of a power converter of the circuit breaker.

16. The method of claim 9, wherein the third operation state comprises:
charging a load capacitor toward a DC bus voltage using a pulse width modulation frequency; and
gradually reducing the pulse width modulation frequency as an output voltage increases toward a DC bus voltage.

17. The method of claim 9, wherein the third operation state includes a plurality of sampling cycles, and further comprising for each of the sampling cycles:
determining a difference between a DC bus voltage and an output voltage;
returning the circuit breaker to the first operation state if the difference is less than a predetermined threshold;
returning the circuit breaker to the second operation state upon determining the third operation state exceeds a predetermined time limit; and
starting a further cycle of the third operation state upon the returning to the second operation state.

18. The method of claim 17, wherein the each of the sampling cycles of the third operation state comprises:
charging a load capacitor toward a DC bus voltage using a pulse width modulation frequency; and
gradually reducing the pulse width modulation frequency until an output current exceeds a predetermined overcurrent threshold.
